(19) United States
(12) Patent Application Publication
(10) Pub. No.: US 2012/0048050 A1
(43) Pub. Date: Mar. 1, 2012

(54) SHIFT LEVER DEVICE

(75) Inventor: Keisuke KINO, Hamamatsu-shi (JP)

(73) Assignee: FUJI KIKO CO., LTD., Kosai-shi (JP)

(21) Appl. No.: 13/217,487

(22) Filed: Aug. 25, 2011

(30) Foreign Application Priority Data
Aug. 27, 2010 (JP) P2010-190695

(51) Int. Cl. F16H 63/38

(52) U.S. Cl. 74/473.25

(57) ABSTRACT

In a shift lever device, the upward movement of a pull rod 45 within a shift lever 4 separates an engaging portion 48 from detent grooves 21, and the downward movement of the pull rod 45 within the shift lever 4 engages the engaging portion 48 with the detent grooves 21 in a shift direction. The shift lever device includes a restricting arm 44 protruding from the shift lever 4 along a shift pivot shaft 30, and a swing limiter 23 disposed along the shift direction in such a manner as to be engageable with and disengageable from the restricting arm 44. When the shift lever 4 is swung in the shift direction, the swinging of the shift lever 4 in a select direction Y is restricted or permitted by the swing limiter 23 engaging with or disengaging from the restricting arm 44.

### TECHNICAL FIELD

The present invention relates to a shift lever device including a shift lever which is switched among shift positions by the operation of swinging the shift lever.

### BACKGROUND ART

Conventional shift lever devices of this type include one having a normal A/T (automatic transmission) mode and also having an M (manual) mode which allows a driver to manually shift up or down through gears. A conventional example of this type has been disclosed in Patent Literature 1.

As shown in FIG. 1, a shift lever device 100 disclosed in Patent Literature 1 includes a body-side housing 101 made of resin, and a shift lever 102 supported by the housing 101 to be swingable in a shift direction X (longitudinal direction of a vehicle body) and a select direction Y (width direction of the vehicle body). In this shift lever 102, a position pin 103 protruding to both sides in the select direction is provided to be movable in the axial direction of the shift lever 102. A knob button (not shown) is attached to an upper portion of the shift lever 102. The knob button is connected to the position pin 103 through a compression rod (not shown) inserted through the shift lever 102, and the position pin 103 is biased upward in the axial direction of the shift lever 102 by a coil spring (not shown) through the compression rod. The housing 101 includes position gates 104 and 105 which are placed on two sides of the shift lever 102 that are opposite to each other in the select direction and with which opposite ends of the position pin 103 engage, respectively.

In this conventional example, in the normal A/T mode, any one range is selected by swinging the shift lever 102 in the shift direction X. Moreover, at the time of switching to a P (parking) range, when a driver performs the operation of pressing the knob button at the upper portion of the shift lever 102, the compression rod inserted through the shift lever 102 is biased against an elastic force of the coil spring, and therefore the position pin 103 is lowered. In this state, by swinging the shift lever 102 to the P range side, the position pin 103 is moved to the position of the P range in the position gate 104. Similarly, in a state in which the driver performs the operation of pressing the knob button at the upper portion of the shift lever 102 to lower the position pin 103, the shift lever 102 is switched from the P range to the D range side.

Moreover, in the M mode, by swinging the shift lever 102 in the select direction (direction indicated by an arrow 106), switching to the M mode is performed. In this state, manual gear shifting (upshifting or downshifting) is performed in accordance with the operation of the shift lever 102 in the shift direction X. At this time, one end of the position pin 103 touches an edge of an upper end of the position gate 105. Thus, the compression rod inserted through the shift lever 102 is biased against the elastic force of the coil spring, and therefore the position pin 103 is lowered in the axial direction of the shift lever 102. Accordingly, the driver can switch from the normal A/T mode to the M mode without an effort to manually operate the knob button at the upper portion of the shift lever 102.

### CITATION LIST

### Patent Literature

[Patent Literature 1] Japanese Patent Application Laid-open No. Hei 09-263152

### SUMMARY OF INVENTION

### Technical Problems

The aforementioned technology described in Patent Literature 1 is a shift lever device of a so-called push-rod type, and therefore does not require an effort to manually operate the knob button at the upper portion of the shift lever 102 at the time of switching from the normal A/T mode to the M mode. On the other hand, in the case of a shift lever device of a pull-rod type in which a pull rod is pulled up while the knob button is being pushed at the time of switching ranges, rattle in the select direction is prevented by inserting a detent portion into an approximately U-shaped engaging portion formed at a lower end of the pull rod. Accordingly, at the time of switching from the normal A/T mode to the M mode, the lower end of the pull rod needs to be pulled up out of a detent groove portion by manually operating the knob button at the upper portion of the shift lever. Thus, there has been the problem of poor operability.

Accordingly, the present invention has been made to solve the above-described problem, and an object of the present invention is to provide a shift lever device which can improve operability while reducing the rattle of a shift lever of a shift lever device of a pull-rod type.

### Solution to Problems

A first aspect of the present invention is a shift lever device including: a shift block disposed on a housing fixed to a vehicle body, and configured to swing about a shift pivot shaft; a shift lever mounted to the shift block and configured to swing about a select pivot shaft; a pull rod housed in the shift lever in such a manner as to be movable in the axial direction of the shift lever; an engaging portion provided at a lower end of the pull rod; a detent groove including protrusions and recesses which face the engaging portion and which are disposed along a shift direction; a restricting aim protruding from the shift lever along the shift pivot shaft; and a swing limiter disposed along the shift direction in such a manner as to be engageable with and disengageable from the restricting arm. In the above-described configuration, upward movement of the pull rod within the shift lever separates the engaging portion from the detent groove; downward movement of the pull rod within the shift lever engages the engaging portion with the detent groove in the shift direction; and, when the shift lever is swung in the shift direction, swinging of the shift lever in a select direction is restricted or permitted by the restricting arm engaging with or disengaging from the swing limiter.

A second aspect of the present invention is the shift lever device of the first aspect, wherein the swing limiter includes a select restricting portion formed to have a width of approximately the same dimension as that of the restricting arm in such a manner as to allow movement of the restricting arm along the shift direction within the select restricting portion, and a select permitting portion formed to have a width corresponding to a swing range of the shift lever in the select direction; in the select restricting portion, swinging of the shift lever in the select direction is limited; and in the select permitting portion, swinging of the shift lever in the select direction is permitted.

A third aspect of the present invention is the shift lever device of any one of the first and second aspects, further including a check pin held at a tip of the restricting arm in the state of being biased to be extendable and retractable, and a check block mounted to the housing, the check block includes a check groove with which the check pin slides in pressure contact.

### Advantageous Effects of Invention

In the first aspect of the present invention, when a driver moves the pull rod upward within the shift lever in a state in which the engaging portion is in engagement with the detent groove, the engaging portion is separated from the detent groove, and the engaging portion and the detent groove are thrown out of engagement in the shift direction to remove restrictions on the movement of the shift lever in the shift direction. Then, when the driver operates the shift lever in the shift direction, both the shift block and the shift lever integrally swing in the shift direction about the shift pivot shaft mounted to the housing. At this time, the restricting arm provided in the shift lever engages with the swing limiter. Thus, the movement of the shift lever in the shift direction is permitted while the movement of the shift lever in the select direction is being restricted. Accordingly, the rattle of the shift lever can be reduced.

Moreover, in a state in which the shift lever is placed at a predetermined position in the shift direction, the restricting arm is thrown out of engagement with the swing limiter to remove limitations on the movement of the shift lever in the select direction. This allows the shift lever to swing in the select direction about the select pivot shaft mounted to the shift block.

Thus, when the shift lever is swung in the select direction at the predetermined position in the shift direction, the pull rod does not have to be moved upward. Accordingly, operability can be improved.

In the second aspect of the present invention, the select restricting portion is formed to have a width of approximately the same dimension as that of the restricting arm and to allow the movement of the restricting arm along the shift direction within the select restricting portion, and the select permitting portion is formed to have a width corresponding to the swing range of the shift lever in the select direction. Accordingly, in a state in which the restricting arm is placed in the select restricting portion, the swinging of the shift lever in the select direction is limited; and, in a state in which the restricting arm is placed in the select permitting portion, the swinging of the shift lever in the select direction is permitted.

In the third aspect of the present invention, the check pin attached to the tip of the restricting arm to be extendable and retractable is held in the state of being biased upward from the restricting arm, and the check pin is in pressure contact with the check groove of the check block mounted to a base bracket included in the housing. In this state, the operation of swinging the shift lever causes the check pin to slide in the check groove, and warps the elastic member. Accordingly, a crisp feel is provided. Thus, since the restricting aim can be used both for restrictions on the movement of the shift lever and for the provision of a crisp feel, it is possible to provide a crisp feel and improve operability with a small number of parts.

### BRIEF DESCRIPTION OF DRAWINGS

FIG. 1 is a perspective view showing a conventional shift lever device.

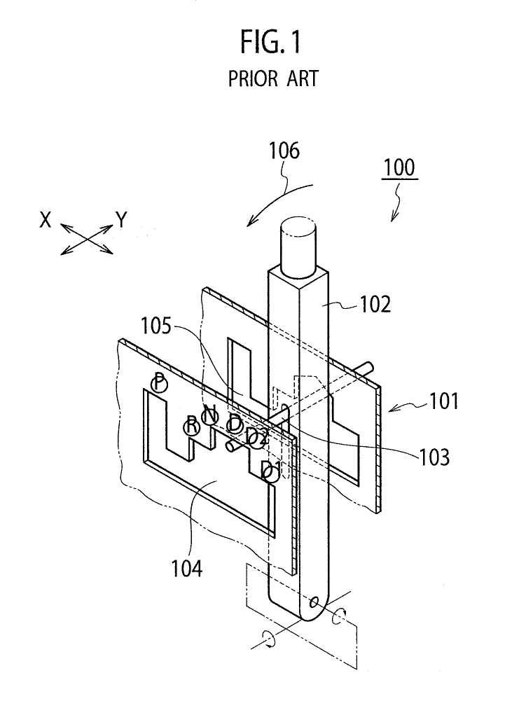

FIG. 2 shows a first embodiment of the present invention, and is an exploded perspective view of a shift lever device.

FIG. 3 shows the first embodiment of the present invention, and is an explanatory diagram of the shift lever device in an A/T mode.

FIG. 4 shows the first embodiment of the present invention, and is a cross-sectional view of the shift lever device in an M mode.

FIG. 5 shows a second embodiment of the present invention, and is an exploded perspective view of a shift lever device.

FIG. 6 shows the second embodiment of the present invention, and is a perspective view showing a check block.

FIG. 7 shows the second embodiment of the present invention, and is an explanatory diagram of the shift lever device in an A/T mode.

FIG. 8 shows the second embodiment of the present invention, and is a cross-sectional view of the shift lever device in an M mode.

### DESCRIPTION OF EMBODIMENTS

Hereinafter, embodiments of the present invention will be described with reference to drawings.

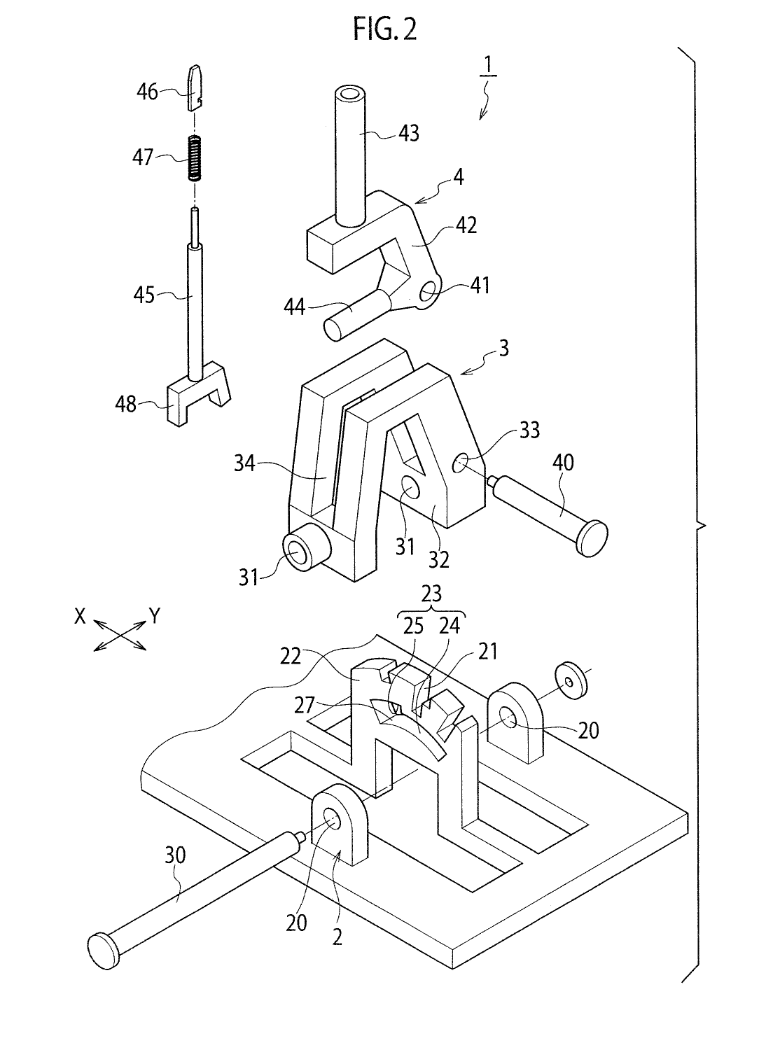

As shown in FIGS. 2 to 4, a shift lever device 1 of a first embodiment includes a shift block 3 mounted to a base bracket 2 included in a housing fixed to a vehicle body (not shown) and configured to swing about a shift pivot shaft 30, and a shift lever 4 mounted to the shift block 3 and configured to swing about a select pivot shaft 40.

The base bracket 2 has a pair of shift bearing holes 20 pivotally supporting the shift pivot shaft 30, and a detent member 22 in which a plurality of detent grooves 21 including protrusions and recesses for restricting the movement of the shift lever 4 in a shift direction X (longitudinal direction of the vehicle body) in an A/T mode are formed in an upper surface thereof facing an undermentioned engaging portion 48. The plurality of detent grooves 21 are consecutively disposed in the shift direction X of the shift lever 4 at positions corresponding to a range pattern. An insertion hole 23 as a swing limiter with which an undermentioned restricting arm 44 of the shift lever 4 engages is formed in the detent member 22. The insertion hole 23 includes a select restricting portion 24 and a select permitting portion 25. The select restricting portion 24 is formed to have a width of approximately the same dimension as that of the restricting arm 44, and guides the restricting arm 44 in the shift direction X in the A/T mode. The select permitting portion 25 is disposed continuously with one end of the select restricting portion 24 and formed to have a width of a larger dimension than that of the select restricting portion 24, and guides the restricting arm 44 in the shift direction X and a select direction Y (width direction of the vehicle body) in an M mode.

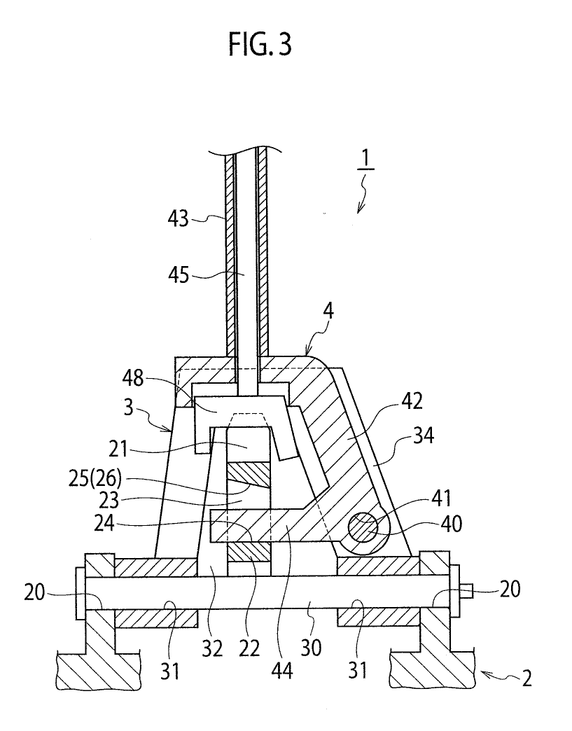

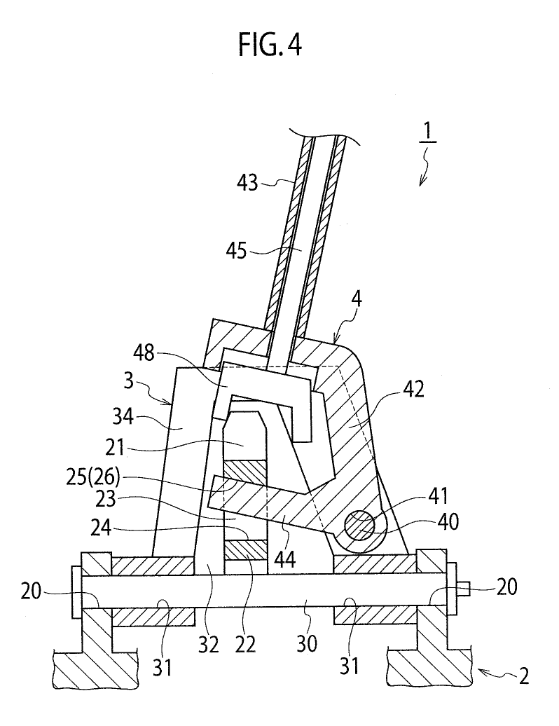

The select restricting portion 24 is extended in the shift direction X such that the swinging of the shift lever 4 about the shift pivot shaft 30 is permitted in the A/T mode in a state in which the restricting arm 44 is inserted through the select restricting portion 24. The select permitting portion 25 is extended in the select direction Y and the shift direction X such that the swinging of the shift lever 4 about the select pivot shaft 40 and the shift pivot shaft 30 is permitted in the M mode in a state in which the restricting aim 44 is inserted through the select permitting portion 25. Moreover, an inclined surface 26 is formed at an upper end of the select permitting portion 25, and a contact surface 27 is formed at a lower end of the select permitting portion 25. In the M mode shown in FIG. 4, the restricting arm 44 which has swung in the select direction Y comes in contact with the inclined surface 26. In the A/T mode shown in FIG. 3, the restricting arm 44 placed in an approximately horizontal position comes in contact with the contact surface 27. The clearance between the inclined surface 26 and the contact surface 27 is set to have a width corresponding to the swing range of the shift lever in the select direction Y, and the inclined surface 26 and the contact surface 27 are used as stoppers when the shift lever 4 swings in the select direction Y.

The shift block 3 has shift shaft holes 31 through which the shift pivot shaft 30 is inserted, a detent-side recessed portion 32 which receives the detent member 22, a pair of select bearing holes 33 which are placed above the shift shaft holes 31 and which pivotally support the select pivot shaft 40, and a lever-side recessed portion 34 which receives an undermentioned basal portion 42 and the restricting arm 44 of the shift lever 4.

The shift lever 4 mainly includes a basal portion 42, a tubular portion 43, a knob (not shown), and the restricting arm 44. The basal portion 42 is inserted in the lever-side recessed portion 34 of the shift block 3, and has at a lower end portion thereof a select shaft hole 41 through which the select pivot shaft 40 is inserted. The tubular portion 43 extends above the basal portion 42. The knob is fixed to an upper end portion of the tubular portion 43, and can be grasped by a driver. The restricting arm 44 is made of a solid cylinder and provided in the vicinity of the select shaft hole 41 in the lower end portion of the basal portion 42.

This restricting arm 44 is extended from a lower end portion of the basal portion 42 in a direction which is perpendicular to the axial direction of the tubular portion 43 and which crosses the axis line of the tubular portion 43, and is inserted through the insertion hole 23 of the detent member 22.

A pull rod 45 is housed in the basal portion 42 and the tubular portion 43 to be movable in the axial direction of the shift lever 4, and an upper end of the pull rod 45 is connected to an operation button (not shown) of the knob through a rod 46 and a coil spring 47. The pull rod 45 has an engaging portion 48 provided at a lower end thereof. The engaging portion 48 protrudes downward (toward the base end) from the basal portion 42, and can engage with the detent grooves 21 of the detent member 22. The pull rod 45 restricts the operation of swinging the shift lever 4 by the engaging portion 48 being held in the state of being biased downward toward the detent grooves 21. The operation of pulling up the rod 46 separates the pull rod 45 from the detent member 22 to permit the operation of swinging the shift lever 4 in the shift direction X.

In the above-described configuration, in the A/T mode, when the driver operates a knob button to remove restrictions on the movement of the shift lever 4 in the shift direction X by the detent grooves 21, and operates the shift lever 4 in the shift direction X, both the shift block 3 and the shift lever 4 integrally swing about the shift pivot shaft 30 mounted to the base bracket 2 in the shift direction X. In this A/T mode, the restricting arm 44 provided in the shift lever 4 moves within the select restricting portion 24 in the state of being inserted through the select restricting portion 24 of the insertion hole 23 of the detent member 22. Thus, the movement of the shift lever 4 in the shift direction X is permitted while the movement of the shift lever 4 in the select direction Y is being limited.

Moreover, in the A/T mode, in a state in which the shift lever 4 is placed at a D range, when the shift lever 4 is swung in the select direction Y to switch from the A/T mode shown in FIG. 3 to the M mode shown in FIG. 4, the shift lever 4 swings in the select direction Y about the select pivot shaft 40 mounted to the shift block 3. With the turn of the restricting atm 44, the engaging portion 48 at a lower end of the pull rod 45 is separated from an upper end of the detent member 22. Accordingly, restrictions on the movement of the shift lever 4 in the shift direction X by the detent grooves 21 are removed. Then, the shift lever 4 which has swung in the select direction Y comes in contact with the inclined surface 26 at the upper end of the select permitting portion 25. Subsequently, when the shift lever 4 is operated in the shift direction X, both the shift block 3 and the shift lever 4 integrally swing about the shift pivot shaft 30 in the shift direction X. Accordingly, the restricting arm 44 provided in the shift lever 4 moves within the select permitting portion 25 in the state of being inserted through the select permitting portion 25 of the insertion hole 23 of the detent member 22. Thus, the movement of the shift lever 4 in the shift direction X and the select direction Y is permitted. Then, when the restricting arm 44 comes in contact with each of two ends of the select permitting portion 25 which are opposite to each other in the shift direction X, the shift lever 4 stops. As a result, in the M mode, manual gear shifting (upshifting or downshifting) is performed in accordance with the operation of the shift lever 4 in the shift direction X.

As described above, according to the present invention, in the A/T mode, the insertion of the restricting aim 44 of the shift lever 4 through the select restricting portion 24 of the insertion hole 23 of the detent member 22 restricts the movement of the shift lever 4 in directions except the shift direction X. Accordingly, the rattle of the shift lever 4 can be reduced. Moreover, in the M mode, when the shift lever 4 is swung in the select direction Y and the shift direction X, manually operating the knob button is not necessary for removing restrictions on the movement of the shift lever 4 in the shift direction X by the detent grooves 21. Accordingly, operability can be improved.

Moreover, according to the present invention, in the A/T mode, when the insertion hole 23 of the detent member 22 guides the restricting arm 44 in the shift direction X, the restricting arm 44 is inserted through the select restricting portion 24 formed to have a width of approximately the same dimension as that of the restricting arm 44. Thus, the movement of the shift lever 4 in the select direction Y can be reliably restricted. Moreover, in the M mode, when the insertion hole 23 of the detent member 22 guides the restricting arm 44 in the shift direction X and the select direction Y, the restricting arm 44 which has swung in the select direction Y comes in contact with the inclined surface 26 provided at one end of the select permitting portion 25. Accordingly, the swing range of the shift lever 4 in the select direction Y is limited.

Moreover, according to the present invention, the detent-side recessed portion 32 of the shift block 3 receives the detent member 22, and the lever-side recessed portion 34 receives the basal portion 42 and the restricting arm 44 of the shift lever 4. Thus, the space around the shift block 3 can be effectively utilized, and therefore the device can be made compact.

Moreover, according to the present invention, a so-called pull-rod type is employed in which the movement of the shift lever 4 in the shift direction X by the detent grooves 21 is restricted using the pull rod 45. Accordingly, the structure of the base bracket 2 can be simplified compared to that of a push-rod type such as heretofore used, and weight reduction and cost reduction can be achieved.

Moreover, according to the present invention, the restricting arm 44 is used as a stopper with the inclined surface 26 at the upper end of the select permitting portion 25 and the contact surface 27 at the lower end of the select permitting portion 25 when the shift lever 4 swings in the select direction Y in the M mode. Accordingly, the swing range of the shift lever 4 in the select direction Y can be reliably set. Similarly, in the case where the shift lever 4 is swung in the select direction Y and the shift direction X in the M mode, the restricting aim 44 is used as a stopper with two ends of the select permitting portion 25 which are opposite to each other in the shift direction X, when the shift lever 4 is swung in the shift direction X. Accordingly, the swing range of the shift lever 4 in the shift direction X can be reliably set.

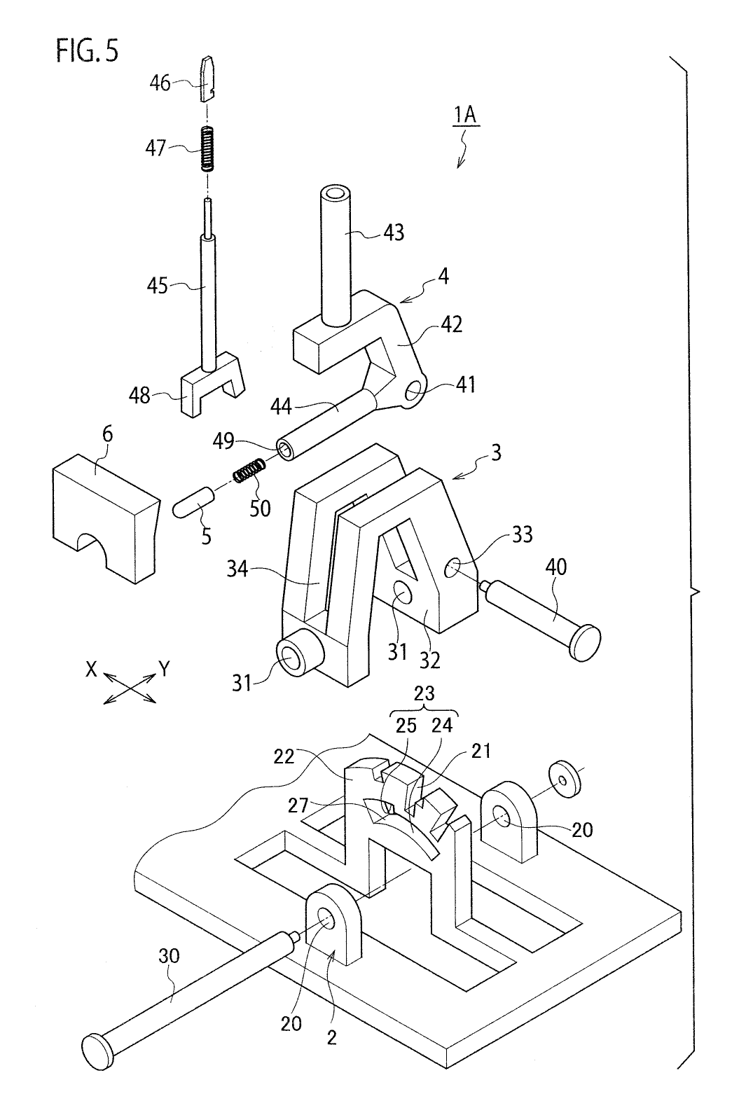

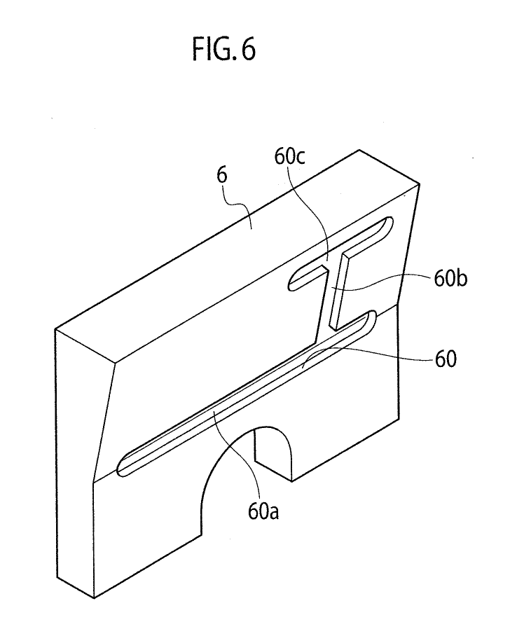

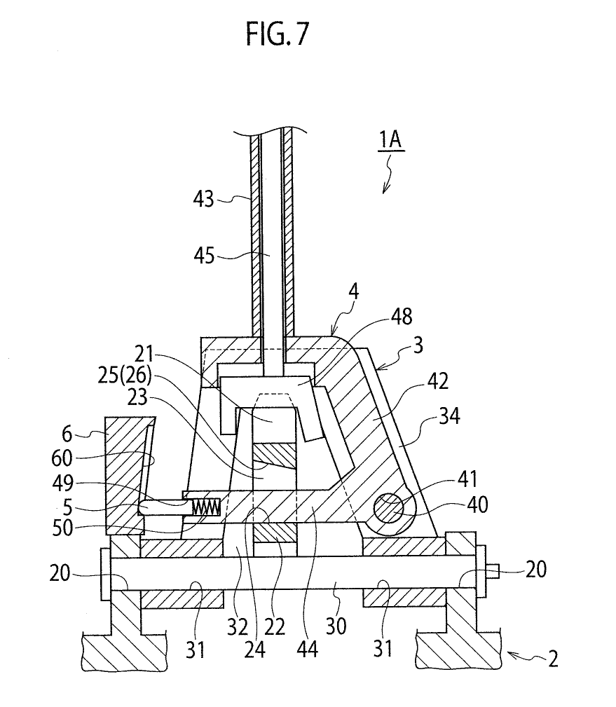

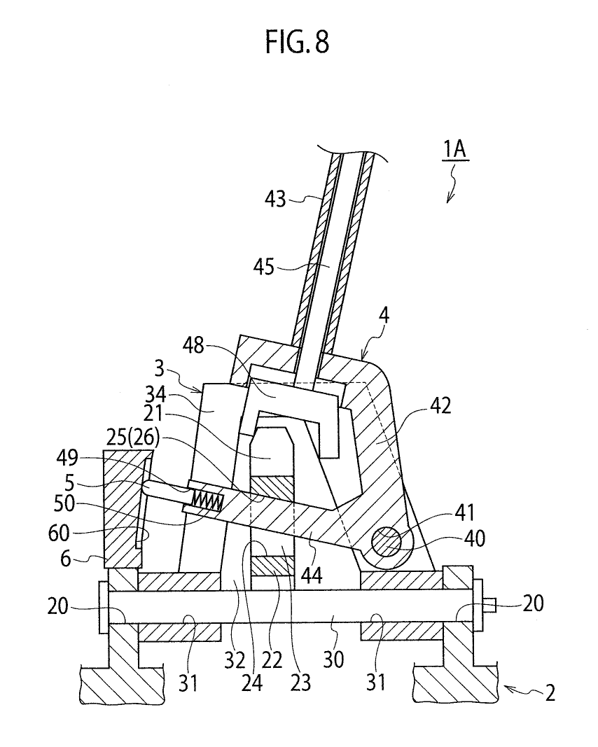

As shown in FIGS. 5 to 8, in a shift lever device 1A of a second embodiment, an insertion hole 49 in which a check pin 5 is inserted to be extendable and retractable is provided at a tip of the restricting arm 44, and the check pin 5 is held in the state of being biased upward from the restricting arm 44 by an elastic member 50. Moreover, a check block 6 having a check groove 60 formed in a predetermined shape such as shown in FIG. 6 is mounted to the base bracket 2, and a tip of the check pin 5 is brought into pressure contact with the check groove 60. It should be noted that in FIGS. 5 to 8, portions similar to the aforementioned ones shown in FIGS. 2 to 4 are denoted by the same reference numerals.

In the above-described configuration, the check pin 5 attached to a tip portion of the restricting arm 44 is held in the state of being biased upward from the restricting arm 44, and the check pin 5 is brought into pressure contact with the check groove 60 of the check block 6 mounted to the base bracket 2. In this state, the operation of swinging the shift lever 4 causes the check pin 5 to slide in the check groove 60 of the check block 6, and warps the elastic member 50. Accordingly, a crisp feel is provided. Specifically, in the A/T mode, the check pin 5 is brought into pressure contact with a check groove 60a; when the shift lever 4 is moved from the A/T mode to the M mode in the select direction Y, the check pin 5 moves in a check groove 60b while being in pressure contact therewith; and, in the M mode, in the movement of the shift lever 4 in the shift direction X, the check pin 5 is brought into pressure contact with a check groove 60c.

As described above, according to the present invention, since the restricting arm 44 can be used both for restrictions on the movement of the shift lever 4 and for the provision of a crisp feel, it is possible to provide a crisp feel and improve operability with a small number of parts.

It should be noted that though in the aforementioned second embodiment, the case where the check pin 5 attached to the tip portion of the restricting atm 44 is held in the state of being biased upward from the restricting atm 44 has been described as an example, the present invention is not limited to this. The check pin 5 provided separately from the restricting arm 44 may be held in the state of being biased in a direction parallel to the axis line of the shift lever 4. Moreover, instead of using the check pin 5 held in the state of being biased, a crisp feel can also be provided by a leaf spring member. Furthermore, by providing an elastic member made of resin, rubber, or the like around the insertion hole 23, hammering due to contact with the restricting arm 44 can be prevented.

It should be noted that Japanese Patent Application No. 2010-190695 (filed on Aug. 27, 2010) is incorporated herein by reference in its entirety.

The present invention is not limited to the description of the aforementioned embodiments of the invention, and can be carried out in other various aspects by making appropriate modifications.

What is claimed is:

1. A shift lever device, comprising:
a shift block disposed on a housing fixed to a vehicle body, and configured to swing about a shift pivot shaft;
a shift lever mounted to the shift block and configured to swing about a select pivot shaft;
a pull rod housed in the shift lever in such a manner as to be movable in the axial direction of the shift lever;
an engaging portion provided at a lower end of the pull rod;
a detent groove including protrusions and recesses which face the engaging portion and which are disposed along a shift direction;
a restricting arm protruding from the shift lever along the shift pivot shaft; and
a swing limiter disposed along the shift direction in such a manner as to be engageable with and disengageable from the restricting arm,
wherein
upward movement of the pull rod within the shift lever separates the engaging portion from the detent groove;
downward movement of the pull rod within the shift lever engages the engaging portion with the detent groove in the shift direction; and
when the shift lever is swung in the shift direction, swinging of the shift lever in a select direction is restricted or permitted by the restricting arm engaging with or disengaging from the swing limiter.

2. The shift lever device according to claim 1, wherein
the swing limiter comprises:
a select restricting portion formed to have a width of approximately the same dimension as that of the restricting arm in such a manner as to allow movement of the restricting aim along the shift direction within the select restricting portion; and
a select permitting portion formed to have a width corresponding to a swing range of the shift lever in the select direction;
in the select restricting portion, swinging of the shift lever in the select direction is limited; and
in the select permitting portion, swinging of the shift lever in the select direction is permitted.

3. The shift lever device according to claim 1, further comprising:
a check pin held at a tip of the restricting arm in the state of being biased to be extendable and retractable; and
a check block mounted to the housing, the check block comprising a check groove with which the check pin slides in pressure contact.

4. The shift lever device according to claim 2, further comprising:
a check pin held at a tip of the restricting arm in the state of being biased to be extendable and retractable; and
a check block mounted to the housing, the check block comprising a check groove with which the check pin slides in pressure contact.
